(19) United States
(12) Patent Application Publication
(10) Pub. No.: US 2002/0180269 A1
(43) Pub. Date: Dec. 5, 2002

(54) Method for making allowance for the vehicle attitude on operating cosing piece systems on motor vehicles

(76) Inventors: Lambros Dalakuras, Birkenfeld (DE); Volker Breunig, Ditzingen (DE); Frank Schmidt, Leonberg (DE)

Correspondence Address: Striker Striker & Stenby, 103 East Neck Road, Huntington, NY, 11743, US

(21) Appl. No.: 10/130,153

(22) PCT Filed: Sep. 8, 2001
(86) PCT No.: PCT/DE01/03450

(30) Foreign Application Priority Data
Sep. 14, 2000 (DE) 100 45 341.4

(51) Int. Cl. B60L 1/00

(52) U.S. Cl. 307/9.1

(57) ABSTRACT

The invention relates to a method for actuating closing part systems with actuators (8) in motor vehicles. The actuators (8) in motor vehicles can be electrically or hydraulically operable drive mechanisms. The closing part components are optionally monitored by means of pinch prevention detectors (10) and adapters (17), which take external disturbance variables (2, 3) into account. In the case of controllers (27) of closing part systems, a vehicle inclination signal N_{α} (24), upon ascertainment of the controlling variable (5) Y(t), and in the case of regulators (20) a reference signal Xᵣ(t) (15), is switched to a pinch prevention detector (10) downstream of them, which reference signal is modified by the vehicle inclination signal (27).

### FIELD OF THE INVENTION

The requisite driving force for opening and closing electrically or hydraulically operated closing part systems in motor vehicles is dependent on the vehicle inclination, because of the intrinsic mass of the closing part components. Examples of closing part systems in motor vehicles that can be named are sliding doors, roof part systems, tailgates or hatchbacks, and so forth. In a vehicle in an inclined position, increased frictional forces can occur at the suspension points of the closing part systems and can additionally affect the driving force required to move the closing part system. In sliding doors that are actuated when the motor vehicle is in an inclined position, this effect is especially pronounced, because of the high intrinsic mass of the sliding doors.

### PRIOR ART

In the presently known controllers and regulators for hydraulically or electrically actuatable closing part systems in motor vehicles, the vehicle inclination is not taken into account in ascertaining the driving forces via the control motors. Thus far, the only variables that have been taken into account are the battery voltage fluctuations and fluctuations in the outdoor temperature, which are taken into account in the context of a controlling variable compensation at the actuators. In controllers of closing part systems without passive pinch prevention, a disturbance variable compensation directly affects the controlled variable, such as the driving rpm. Providing controllers without passive pinch prevention makes sense only if the controlling variable can be varied continuously. As a rule, the set-point rpm is specified as the guide variable. The disturbance variable is calculated taking such disturbance variables as battery voltage fluctuations and outdoor temperature fluctuations into account. At the output of such a controller, the controlled variable is then established, in the form of the rpm. In regulators without passive pinch prevention, a disturbance variable compensation is unnecessary, since the influence of the disturbance variable is eliminated by the regulator itself. In such systems, the guide variable set-point rpm is specified. The controlled variable is detected via a sensor unit and fed back to the regulator, so that the disturbance variable, such as a pulse width modulated voltage, is determined solely from the ascertained control deviation. At the output of a controlled system of this kind, the controlled variable is then established in the form of an actual rpm.

In systems, whether they are regulators or controllers, with passive pinch prevention the assumption is that the controlling variable cannot be varied continuously. Accordingly, the actuator of the closing part system can only be turned on or off. Fluctuations in the battery voltage or temperature directly affect the rpm. Such systems can be used in motor vehicles, for instance for triggering power windows. In the passive pinch prevention, the controlled variable or a signal derived from it is compared with a reference signal. An evaluation unit evaluates the deviations in the controlled variable and reference signal over time and decides whether a pinching situation is present or not. The reference signal is read out from a memory, which the evaluation unit can access at any time, determined taking the current disturbance variables into account. In a system of this kind, current disturbance variables can for instance be battery voltage fluctuations or temperature fluctuations.

In controllers with adaptive passive pinch prevention, the reliability of the pinch prevention is determined definitively by the reference signal. In some systems, the reference stored in the memory is therefore adapted during operation to the altered ambient conditions, such as aging and wear. A controller of this kind is maximally identical to the controller discussed above, except for the adaptation of the reference signals stored permanently in the memory, whose change over time can be taken into account by means of the adaptation.

In adaptive regulators without passive pinch prevention, a disturbance variable compensation is not necessary, since the influence of the disturbance variable is eliminated by the regulator. The controlled variable is detected via a sensor unit and fed back to the regulator. In conjunction with a monitoring or adaptation of the controlled system, however, it is appropriate also to take the influence of the controlling variables into account in the evaluation. In these systems, the regulating behavior is adapted to the varying ambient conditions. The varying ambient conditions, such as temperature fluctuations or battery voltage fluctuations, are now no longer ascertained in the context of ascertaining the reference signal but instead enter the adaptation component directly. In regulating systems with adaptive passive pinch prevention, as in the controllers with passive pinch prevention, comparisons are made with reference signals stored permanently in a memory. In adaptive systems, as in the controller with adaptive passive pinch prevention, the reference signal is likewise subject to changing ambient conditions; that is, changing ambient conditions affect the values, stored permanently in the memory, of the reference signals that the evaluation electronics access.

### SUMMARY OF THE INVENTION

With the method proposed according to the invention for taking the vehicle inclination into account in actuating closing elements in motor vehicles, via either hydraulic or electric motor actuators, it is possible in regulators and controllers with passive pinch prevention to compensate for the change in driving force when the vehicle is on an incline and to monitor ensuing force changes. The reliability of drive systems with passive pinch prevention can be durably enhanced by taking the resultant vehicle inclination into account. Especially in the actuation of sliding doors, which have a high intrinsic mass, of a motor vehicle in an inclined position, the closing forces required to actuate the sliding doors in the inclined state can be determined substantially better. In every case, it must be assured that, even in the inclined state, the pinch prevention remains assured, in order to guarantee that in a sliding door that has to be actuated with greater closing force when the vehicle is in an inclined position, the passive pinch prevention will not be overridden. With the method proposed according to the invention, the sensitivity of systems with passive pinch prevention can be enhanced significantly, taking the resultant vehicle inclination into account.

Moreover, with the method proposed according to the invention for taking the vehicle inclination into account in actuating closing part systems in motor vehicles by external force, substantially greater comfort and convenience can be achieved, and increased reliability of these closing part components can be brought about. The adaptation of the as a function of the vehicle inclination and as a function of the frictional forces that are caused by the intrinsic mass of the closing part components and that vary with the vehicle inclination can be detected by an inclination sensor to be provided separately. Advantageously, with the method proposed according to the invention, an inclination sensor that is for instance already provided in the vehicle in conjunction with a theft warning system or restraint system can be integrated into the data transmission bus, of the kind that is already usual in many modern motor vehicles, so that no additional effort and expense must be borne for cabling or wiring; instead, an existing inclination sensor provided for other systems can be employed, assigning it an additional function for inclination detection.

### DRAWING

The invention will be described in further detail below in conjunction with the drawing.

Shown are:

FIG. 1, control of a closing part component in a motor vehicle by means of an actuator, with passive pinch prevention monitored by adaptation;

FIG. 2, an adaptive regulator of an actuator of a closing part component without passive pinch prevention;

FIG. 3, a regulator of the actuator of a closing part face, actuated by external force, with adaptive passive pinch prevention;

FIG. 4, a controller arrangement for a controller, actuated by external force, of a closing part component with control units, communicating via a data bus, of two different monitoring systems; and

FIG. 5, a controlled system for taking the inclination angle information of an inclination angle detector into account, in an actuator with passive pinch prevention in a motor vehicle.

### VARIANT EMBODIMENTS

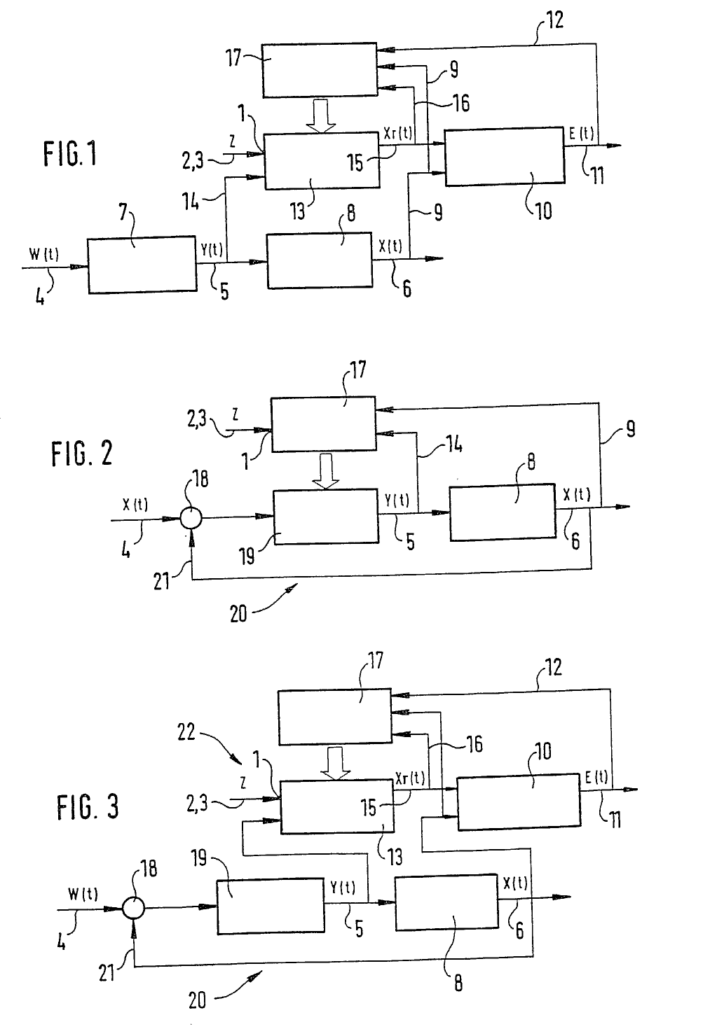

In this controller configuration known from the prior art, the reliability of detecting the pinching situation is definitively dependent on the quality of the reference signal Xᵣ(t). The version in FIG. 1, already known from the prior art, includes a controller 7, which is supplied with a guide variable 4 W(t). From the supplied guide variable 4, the controller ascertains a controlling variable 5 Y(t). The controlling variable is supplied to an electrical or hydraulic actuator 8 downstream of the controller component 7. At its output, the rpm 6 (X)t is the result. In the configuration of FIG. 1, the controlling variable 5 is picked up at 14 and delivered to a reference memory. Via the pickup 14, not only the controlling variable 5 present on the inlet side of the reference memory 13 but also the disturbance variables for battery voltage U_{batt} and the temperature are present at its controlling variable input 1.

On the output side of the actuator 8, the actual rpm of the actuator 8 is delivered via the pickup 9 to an evaluation circuit for detecting a pinching situation 10. Its output signal 11 is fed back to an adaptor via a signal feedback 12; the signal for the actual rpm of the actuator that is picked up on the output side of the actuator 8 is also delivered to the adaptor 17 via the pickup 9, and the reference signal 15 Xᵣ(t) generated on the output side of the reference memory 13 is likewise carried to the adaptor via the reference signal pickup 16.

The reference signal 15 permanently stored in the reference memory 13 is now on the one hand affected by the disturbance variables 2 and 3 switched to the reference memory 13 and on the other, by means of the higher-order adaptor 17 in the reference memory 13, is adapted to the altered ambient conditions, such as aging or wear of the components.

The configuration shown in FIG. 2 illustrates an adaptive regulation without a passive pinch prevention of an actuator 8.

In contrast to the configuration shown in FIG. 1, the disturbance variables 2 and 3, representing the battery voltage fluctuations and the temperature fluctuations, are applied directly to the input side of the adaptor 17. The adaptor 17 is moreover acted upon, via a controlled variable pickup 9, by the controlled variable 6, which is present on the output side of the actuator 8. The adaptor is also acted upon by the controlling variable 5 Y(t) of the regulator 19 via a controlling variable pickup 14.

The guide variable 4 W(t) delivered to the input side of the regulator is fed to a summation point 18, to which a signal, fed back via a controlled system 20 and representing the controlled variable 6 X(t), is delivered in the same way but with a negative sign.

In regulated systems in the configuration of FIG. 2, a controlling variable compensation is unnecessary, since the influence of the controlling variables 2, 3 is eliminated directly by the regulator 19. In conjunction with monitoring or with an adaptive component 17, however, it makes sense to take the influence of the controlling variables into account as well in the evaluation. In these systems, the regulating behavior is therefore adapted adaptively to the changing ambient conditions.

From the illustration in FIG. 3, a regulator of an actuator with adaptively monitored passive pinch prevention detection is known. As in the controllers with passive pinch prevention (see FIG. 1), in regulated systems with passive pinch prevention 10 a comparison is made with a reference signal Xᵣ(t) 15. Also in this configuration, the reference signal Xᵣ(t), stored in the reference signal memory 13 and identified by reference numeral 15, is subject to an adaptation of altered ambient conditions, of the kind that can occur for instance as a result of the disturbance variables 2, 3, such as battery voltage fluctuations and temperature fluctuations.

FIG. 4 in detail shows two control units, connected to one another via an internal data bus, of two different monitoring systems present in the motor vehicle.

The guide variable 4 W(t) is supplied to the input side of a controller component 27. Also present on the input side of the controller component 27 are the disturbance variables 2, representing battery voltage fluctuations, disturbance variables 3 representing a temperature change, and the vehicle inclination signal 24 N_{α} originating in an interface 25 existing in the control unit 23.

On the output side of the controller component 27, the controlling variable 5 Y(t) is obtained, which on the input side acts on a hydraulic or electric actuator 8. The actual rpm X(t), also identified by reference numeral 6, is present on the output side of the exemplary embodiment 8 and drives the actuating closing part component of the motor vehicle.

In the variant embodiment of the method proposed according to the invention in accordance with FIG. 4, the forwarding of the vehicle inclination angle signal 24 N_{α} is effected via an internal data bus (such as a CAN) in the vehicle, between the interfaces 25 and 31 of the two control units of different monitoring systems in the motor vehicle. The control unit 23 of a closing part component is for instance a control unit for actuating a sliding door, while the interface 31 below it, communicating over the data bus 26 with the interface 25 of the control unit 23, may be the interface of a theft monitoring system in the motor vehicle. Via the internal data bus 26, the two with control components 25 and 31 communicate in both directions with one another.

The inclination sensor 28 that detects the vehicle inclination can be located in the theft monitoring system and transmits its output signal 29 to an evaluation component, from which the inclination signal 24 is also forwarded to an interface 31, from which it is forwarded via the internal data bus 26 to the interface 25 of the control unit 23 for the closing part component in the motor vehicle. The vehicle inclination N_{α} is picked up with reference to the longitudinal axis of the vehicle and can be detected by the inclination sensor 28, which is mounted at a suitable point in the vehicle. The inclination signal can be furnished either by a sensor 28 already present in the vehicle, which can be provided directly in the sliding door control unit 23, or the signal can be “lent out” by some other application of a further monitoring system in the motor vehicle.

In that case, in FIG. 4, the data forwarding of the inclination signal 24 is transmitted from the location of detection to the location of processing in the control unit 23 for the closing part component in the motor vehicle.

In the controller variant shown in FIG. 4 for the method proposed according to the invention, a controller 27 is assumed in which the set-point rpm is specified as a guide variable in the form of the input signal 4. The drive mechanism 8 that actuates the closing part component is triggered with a pulse width modulated voltage Y(t), representing the controlling variable 5. This pulse width modulated voltage can be varied over the range from 0 to 100%, so that the actual rpm X(t) results on the output side of the actuator 8.

The actual rpm X(t) that results on the output side of the actuator 8 depends on the controlling variable Y(t).

The calculation of the controlling variable Y(t), also identified by reference numeral 5, is done by the equation given below, using suitable operators φₙ:

Y(t)=Φ_{w}{W(t)}+Φ_{bat}{U_{bat}(t)}+Φₜₑₘₚ{Temp(t)}+ΦN_{α}{Nα(t)}.

Here, φₓ{ . . . } are operators to be selected in a suitable way. The influence of the inclination signal N_{α} 24 and an attendant increased or decreased output rpm X(t) on the output side of the actuator 8 are compensated for in this arrangement as shown in FIG. 4.

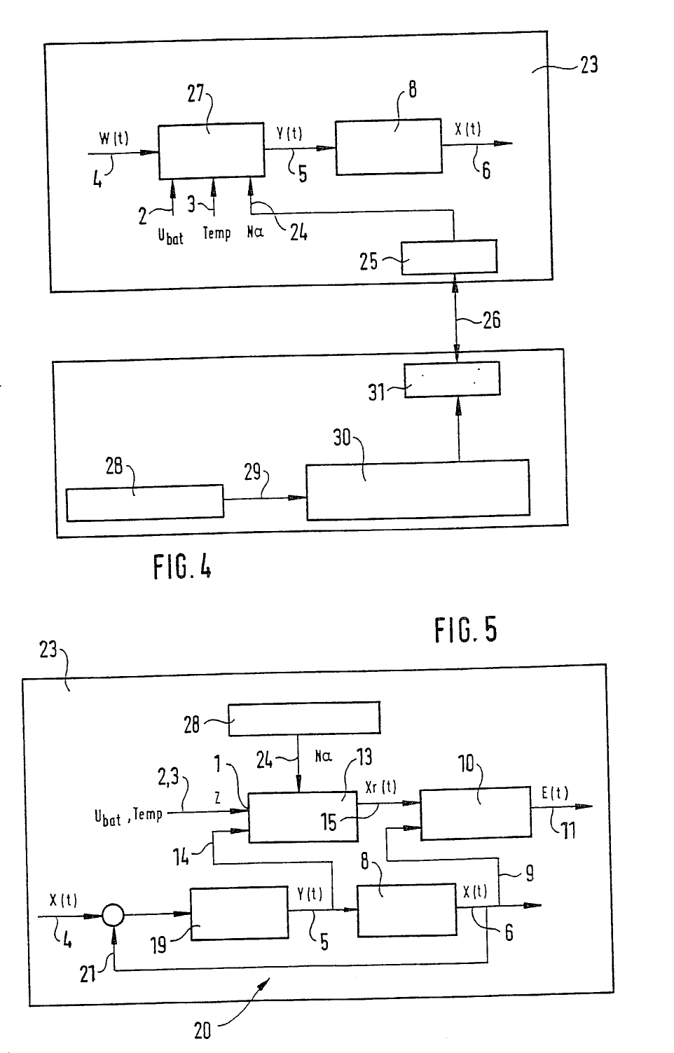

The illustration in FIG. 5 shows a regulator configuration with passive pinch prevention in detail.

In contrast to the controller variant shown in FIG. 4, in the regulator variant the influence of the disturbance variables 2, 3 and 24 is eliminated. The inclination signal N_{α} 24 is required for correcting the reference signal Xᵣ(t) 15 that is stored in the reference value memory 13. In the simplest case, the reference signal Xᵣ(t) can comprise a constant threshold value, which is dependent on the disturbance variables 2 representing the battery voltage fluctuations and 3 representing temperature fluctuations and on the vehicle inclination angle N_{α}. The inclination signal Nα 24 is represented in this example by a sensor 28, which can be received directly in the control unit 23 for the closing part component in the motor vehicle.

The reference signal Xₛ stored in the reference memory 13 and representing a static reference signal can be modified as a function of disturbance variables in accordance with the following equation:

Xᵣ(t)=Xₛ+φ_{bat}{U_{bat}(t)}φₜₑₘₚ{Temp(t)}+φN_{α}{N_{α}(t)}.

Instead of the adaptation of the reference memory 13 by an adaptor 17 that is done in the prior art in accordance with FIG. 3, the signals stored in the reference memory 13 are now modified directly by the vehicle inclination signals N_{α} 24, which are ascertained via a sensor 28 disposed in the control unit 23 of the closing part component.

In the forms of implementation of the method proposed according to the invention that are shown in FIGS. 4 and 5, the disturbance variable N_{α} representing the vehicle inclination, is compensated for. Various advantages can thus be attained, such as more-precise determination of the requisite closing force for actuating a closing part component in a suitable vehicle. Also in systems with passive pinch prevention, the sensitivity can be adjusted much more precisely, resulting in enhanced ease of use and increased reliability of a closing part component, actuated in this way by external force, in the motor vehicle.

List of Reference Numerals

1 Disturbance variable input

2 U_{batt}

3 Temperature

4 Guide variable W(t)

5 Controlling variable Y(t)

6 Controlled variable X(t)

7 Controller

8 Actuator

9 Controlled variable pickup

10 Evaluation circuit for pinch prevention

11 Pinching situation signal

12 Signal feedback

13 Reference memory

14 Controlling variable pickup

15 Reference signal

16 Reference signal pickup

17 Adaptor

18 Summation point

19 Regulating component

20 Controlled system

21 Controlled variable feedback

22 Regulator with adaptive passive pinch prevention

23 Control unit

24 Inclination signal N_{α}

25 Interface with control unit 23

26 Bidirectional data bus (CAN)

27 Controller

28 Inclination sensor

29 Sensor signal

30 Application

Interface of a further monitoring system

1. A method for actuating closing part systems with actuators (8) in motor vehicles, in which the actuators (8) are electrical or hydraulic drive components, and the closing part systems are optionally monitored by pinch prevention detection circuits (10) and adaptations (17), to which disturbance variables (2, 3) are applied, characterized in that in the case of controllers (27), a vehicle inclination signal Nα (24), upon the ascertainment of the controlling variable (5) Y(t), and in the case of regulators (20), a reference signal (15) Xᵣ(t) is sent to a pinch prevention evaluation circuit (10) connected downstream of these, which signal is modified by the vehicle inclination signal N_{α} (24).

2. The method of claim 1, characterized in that in the case of controllers (27), the vehicle inclination signal N_{α} (24) is detected via a sensor (28), which is associated with a further monitoring system in the motor vehicle.

3. The method of claim 2, characterized in that the vehicle inclination signal (24) N_{α} is transmitted via a data bus (26), such as a CAN, between interfaces (25, 31) to two monitoring systems (23).

4. The method of claim 2, characterized in that the controlling variable Y(t) (5) of the controller (24) is compensated for by the inclination signal (24) N_{α} of the inclination sensor (28).

5. The method of claim 1, characterized in that the reference signal Xᵣ(t) (15) is a constant value, dependent on U_{bat} (2) , T (3) and N_{α} (24).

6. The method of claim 1, characterized in that in the case of controlled systems (21), for regulating the controlled variable (6), the influence of the disturbance variables (2, 3, 24) is eliminated.

7. The method of claim 1, characterized in that the vehicle inclination signal N_{α} (24) is furnished by a sensor (28), which is integrated directly with the control unit (23) of the closing part component.

8. The method of claim 3, characterized in that the internal data bus (26) is arranged for data exchange between the two interfaces (25, 31) of the two monitoring systems (23) vehicle internal data bus (26).
